(19) United States
(12) Patent Application Publication
(10) Pub. No.: US 2026/0077930 A1
(43) Pub. Date: Mar. 19, 2026

(54) VACUUM SEALABLE CONTAINER

(71) Applicant: Honeybee Robotics, LLC, Longmont, CO (US)

(72) Inventors: Philip Chu, Manvel, TX (US); Richard Margulieux, Longmont, CO (US); Trenton Mathison, Longmont, CO (US); Kris Zacny, Altadena, CA (US); Justin Spring, Altadena, CA (US); Amelia Grossman, Longmont, CO (US); Meredith McCormick, Longmont, CO (US); Maria Fountas, Pasadena, CA (US); Leo Stolov, Pasadena, CA (US)

(21) Appl. No.: 19/328,777

(22) Filed: Sep. 15, 2025

Related U.S. Application Data
(60) Provisional application No. 63/694,426, filed on Sep. 13, 2024.
(60) Provisional application No. 63/694,415, filed on Sep. 13, 2024.

(51) Int. Cl. B65D 81/20; B65D 55/12

(52) U.S. Cl. CPC B65D 81/2015; B65D 55/12

(57) ABSTRACT

A vacuum sealable container for securing and transporting extraterrestrial samples and a method of securing an extraterrestrial sample is provided. The vacuum sealable container includes a container body and a lid assembly. The lid assembly is connectable to the container body configured to selectively form a hermetic two-way seal between the container body and the lid assembly. A locking mechanism is situated on an end of the lid assembly opposite the container body, the locking mechanism configured to secure the lid assembly to the container body, forming the seal.

### CROSS-REFERENCE TO RELATED APPLICATIONS

This application claims the benefit of U.S. Provisional Ser. No. 63/694,415, filed on Sep. 13, 2024, and U.S. Provisional Ser. No. 63/694,426, filed Sep. 13, 2024. The entire contents of the aforementioned applications are incorporated herein by reference.

### BACKGROUND OF THE DISCLOSURE

The subject matter disclosed herein relates to a vacuum sealable container for transporting an extraterrestrial sample.

Conventional vacuum sealable containers have been designed for robotic missions. A manually operable vacuum sealable container was employed in the Apollo missions with limited capabilities. For example, the container employed in the Apollo missions did not include a design element to more easily extract gas from the container after it was returned to Earth.

Accordingly, while existing vacuum sealable containers are suitable for their intended purposes the need for improvement remains, particularly in providing a vacuum sealable container having the features described herein.

### BRIEF DESCRIPTION OF THE DISCLOSURE

According to one aspect of the disclosure a vacuum sealable container for securing and transporting extraterrestrial samples is provided. The vacuum sealable container includes a container body and a lid assembly. The lid assembly is connectable to the container body configured to selectively form a hermetic two-way seal between the container body and the lid assembly. A locking mechanism is situated on an end of the lid assembly opposite the container body, the locking mechanism configured to secure the lid assembly to the container body, forming the seal.

In addition to one or more of the features described herein, or as an alternative, further embodiments of the vacuum sealable container may include the lid assembly having a knife edge element that forms a seal between the container body and the lid assembly.

In addition to one or more of the features described herein, or as an alternative, further embodiments of the vacuum sealable container may include a gas fitting situated at a distal end of the container body.

In addition to one or more of the features described herein, or as an alternative, further embodiments of the vacuum sealable container may include the gas fitting being configurable between a closed position and an open position, the gas fitting defining a fluid path between the container body and an external environment to allow extraction of one or more gases.

In addition to one or more of the features described herein, or as an alternative, further embodiments of the vacuum sealable container may include a drive tube situated within the container body.

In addition to one or more of the features described herein, or as an alternative, further embodiments of the vacuum sealable container may include a soft dock situated within the container body and proximate to the lid assembly, the soft dock configured to engage the drive tube and prevent rotation and axial motion of the drive tube.

In addition to one or more of the features described herein, or as an alternative, further embodiments of the vacuum sealable container may include the lid assembly further having a dust protector.

In addition to one or more of the features described herein, or as an alternative, further embodiments of the vacuum sealable container may include the lid assembly being connected to the container body by a strap assembly.

In addition to one or more of the features described herein, or as an alternative, further embodiments of the vacuum sealable container may include the container body having an alignment pin that engages with the lid assembly.

In addition to one or more of the features described herein, or as an alternative, further embodiments of the vacuum sealable container may include the locking mechanism having a handle, a locking clamp, a shaft, and a locking bolt. The locking clamp being operably connected to the handle. The shaft being in physical contact with the lid assembly, the locking clamp configured to compress the shaft against the lid assembly. The locking bolt being configured to lock the locking clamp around the shaft.

According to another aspect of the disclosure a method of securing an extraterrestrial sample. The method includes inserting the extraterrestrial sample into a container body. The extraterrestrial sample is enclosed within the container body with a lid assembly, the lid assembly connectable to the container body and configured to selectively form a hermetic two-way seal between the container body and the lid assembly. The seal is formed by securing the lid assembly to the container body with a locking mechanism situated on an end of the lid assembly opposite the container body.

In addition to one or more of the features described herein, or as an alternative, further embodiments of the method may include compressing the sample before enclosing the container body.

In addition to one or more of the features described herein, or as an alternative, further embodiments of the method may include extracting gases from within the container body.

In addition to one or more of the features described herein, or as an alternative, further embodiments of the method may include the gases being extracted through a gas fitting situated at a distal end of the container body from the lid assembly.

In addition to one or more of the features described herein, or as an alternative, further embodiments of the method may include the seal being a knife-edge seal.

In addition to one or more of the features described herein, or as an alternative, further embodiments of the method may include the extraterrestrial sample being contained within a drive tube before insertion into the container body.

In addition to one or more of the features described herein, or as an alternative, further embodiments of the method may include the step of securing the lid assembly to the container body further comprising actuating a handle operably connected to a locking clamp to compress a shaft against the lid assembly, and locking the locking clamp around the shaft with a locking bolt.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a vacuum sealable container in accordance with an embodiment;

FIG. 2 is a perspective view partially in section of the top and bottom portions of a vacuum sealable container in accordance with an embodiment;

FIG. 3A is a perspective sectional view of a container body in accordance with an embodiment;

FIG. 3B is an enlarged sectional view of a top end portion of the container body in accordance with an embodiment;

FIG. 4 is an enlarged partial sectional view of a sealed a vacuum sealable container in accordance with an embodiment;

FIG. 5 is a perspective sectional view of a lid assembly in accordance with an embodiment;

FIG. 6A is a perspective view of a lid assembly in accordance with an embodiment;

FIG. 6B is an alternative perspective view of the lid assembly of FIG. 6A in accordance with an embodiment;

FIG. 7 is a sectional view of a plug compressing a sample within a vacuum sealable container in accordance with an embodiment;

FIG. 8 is a sectional view view of a drive tube in accordance with another embodiment;

The detailed description explains embodiments of the disclosure, together with advantages and features, by way of example with reference to the drawings.

### DETAILED DESCRIPTION OF THE DISCLOSURE

A disadvantage of the vacuum sealable container employed on the Apollo missions was the lack of consideration for preventing leaking of volatile samples. Soil samples or core samples, such as regolith, obtained from extraterrestrial environments often contain entrained gasses within the sample. As the number of scientific and commercial extraterrestrial endeavors increases, containers are needed that provide additional protective capabilities.

Commonly used containers were designed for robotic use. There is therefore a need for solutions that are adapted for manual use by astronauts during missions. While existing vacuum sealable containers are suitable for their intended purposes the need for improvement remains, particularly in providing a container having the features described herein.

Embodiments of the present disclosure protect against contamination of the contained sample and seal against internal pressure created by the volatilization that may occur as the temperature of a lunar sample increases. Further embodiments of the present disclosure provide a two-way seal that prevents volatiles under pressure from escaping from the container and prevents atmospheric air from infiltrating the sealed container upon moving the container into a pressurized environment, whether on the Moon, Earth, or another extraterrestrial body for example.

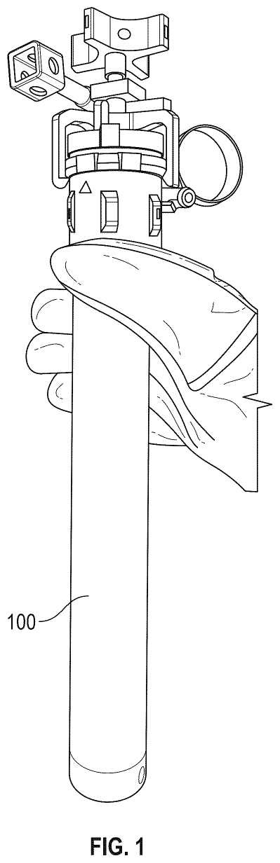

Referring now to FIG. 1, an embodiment is shown of a vacuum sealable container 100. It should be appreciated that while embodiments herein may refer to the use of the vacuum sealable container 100 with respect to a particular application, such as collection of a sample from an extraterrestrial location, such as the Moon or it's lunar surface, this is for example purposes and the claims should not be so limited. In other embodiments, the vacuum sealable container 100 described herein may be used in connection with sample collection from other terrestrial or extraterrestrial bodies, such as but not limited to Mars, asteroids, Kupier Belt objects, and Trans-Neptunian objects for example. In still further embodiments, the vacuum sealable container 100 may be used on moons/satellite objects of other solar system planets, such as Titan or Europa for example.

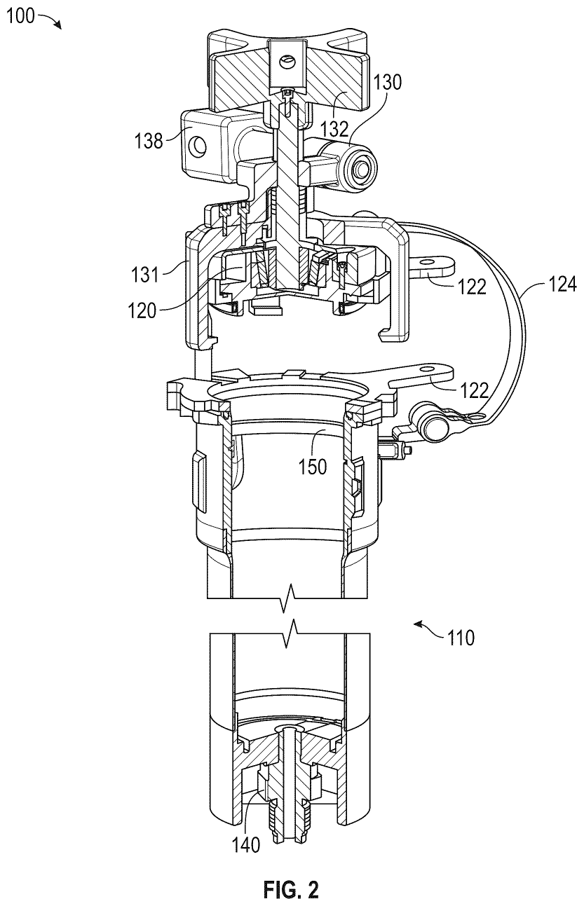

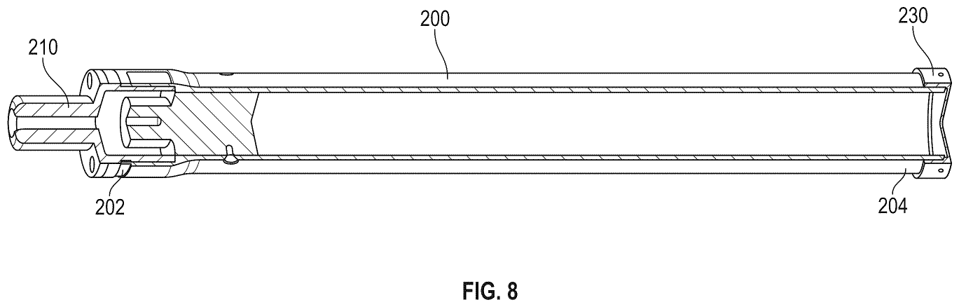

FIG. 2 is an internal view of the top and bottom portions of the vacuum sealable container 100. The vacuum sealable container 100 may include a container body 110 configured to secure a sample. Exemplary samples include soil, regolith, minerals, fossils, and the like. The container body 110 may be composed of a metal, for example aluminum or a stainless steel. The Figures depict a cylindrical container but one of skill the art will recognize that the shape of the body 110 may vary in size and shape. In some embodiments, the container body 110 may receive a drive tube 200 containing the sample. The drive tube 200 is discussed in further detail below with respect to FIG. 8.

The container 100 may further include a lid assembly 120 connectable to the container body 110. The lid assembly 120 may be configured to selectively form a hermetic two-way seal between the container body 110 and the lid assembly 120. The container 100 may further include a locking mechanism 130 situated on an end of the lid assembly 120 opposite the container body 110. The locking mechanism 130 may be configured to secure the lid assembly 120 to the container body 110, locking the seal between the container body 110 and the lid assembly 120 in place.

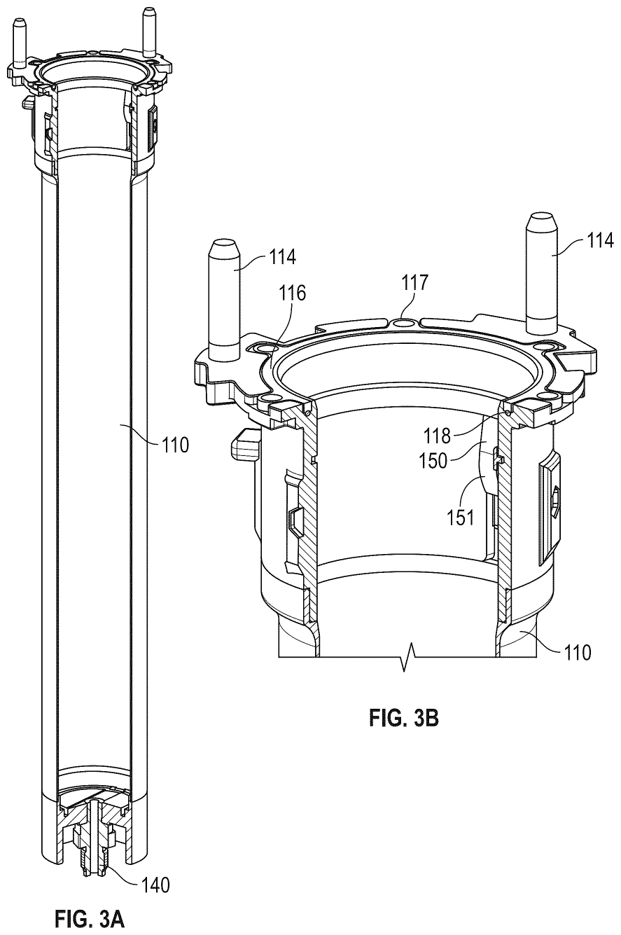

In some embodiments, the container 100 includes a gas fitting 140 or valve situated at a distal end of the container body 110 from the lid assembly 120. As depicted in FIG. 3A, the gas fitting 140 may be configured to allow extraction of one or more gases from within the container body 110. In some embodiments, gases are extracted through the gas fitting 140 to form a vacuum within the container body 110. Extraction of the gases reduces the volatility of the sample, particularly when heated or brought into a pressurized environment. The gas fitting 140 provides further advantages in allowing the removed gases to be analyzed separately from the soil sample.

Gas fitting 140 may include a puncture seal. For instance, the puncture seal may include a layer of material configured to be selectively punctured or pierced (e.g., by a needle, hose, etc.). Additionally or alternatively, gas fitting 140 may include a valve, such as a fill-drain valve, a butterfly valve, a gate valve, a needle valve, a ball valve, or the like. In still further embodiments, gas fitting 140 may include a latching gasket flange. Such gas fittings may provide advantages in allowing for leak testing and qualifications of the container before flight (e.g. re-usable) and also provide access to gas stored in the container.

Referring now to FIG. 3B, the container body 110 may include a soft dock 150 situated within the container body 110 and proximate to the lid assembly 120. The soft dock 150 may be configured to prevent rotation and axial motion of a drive tube 200 within the body 110. The soft dock 150 may also prevent lateral motion of the drive tube 200. In an embodiment, the soft dock 150 includes a member 151 that applies a biasing force on the drive tube 200.

In an embodiment, the member 151 is a projection on the soft dock 150. In an embodiment, the soft dock 150 includes three projections. The member(s) 151 provides an interface to and friction fit (e.g. squeezes) on shallow grooves on the drive tube 200 to reduce the risk of or prevent rotation and axial motion, while also allowing the drive tube 200 to be inserted with a relatively low force. Reducing the risk of, or preventing the rotation of, the drive tube 200 is advantageous in that it allows the operator to disconnect or unscrew the keeper 210 while holding on to the container body 110. Reducing the risk of, or preventing, the axial motion of the drive tube 200 is desirable to avoid having the drive tube 200 fall out of the container body 110.

Soft dock 150 may include a metal spider design that deflects when drive tube 200 is inserted. The metal spider may grab onto drive tube to prevent motion (e.g., radial, axial, etc.). In some embodiments, there may be features on the drive tube that interface to the spider that prevents rotation.

Soft dock 150 may further include a spring-loaded mechanism with fingers that fold out of the way as the drive tube is inserted. As the drive tube clears the mechanism, the fingers may be biased to deflect back up to retain the drive tube. Advantageously, this may reduce the amount of force used to insert the drive tube and provides a high retention force in the axial direction.

Soft dock 150 may further include a spring energized seal that allows the drive tube to be inserted and springs out to hold it in place. In some embodiments this allows the drive tube to be inserted all the way through or can be positioned to preload against the top features of the drive tube to hold it radially as well.

In some embodiments, soft dock 150 may include a secondary insert that interfaces with the container and drive tube to lock the drive tube in place, a leaf spring design that grips onto the drive tube to prevent motion, or an aperture or hyperboloid that grasps the drive tube in 360 degrees by closing around the drive tube after insertion. This may prevent motion radially as well as preventing some vertical motion from the number of points of contact.

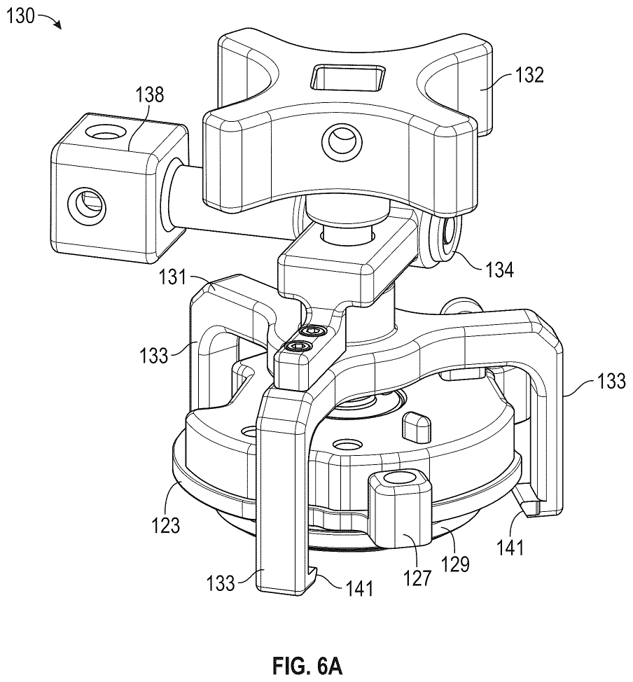

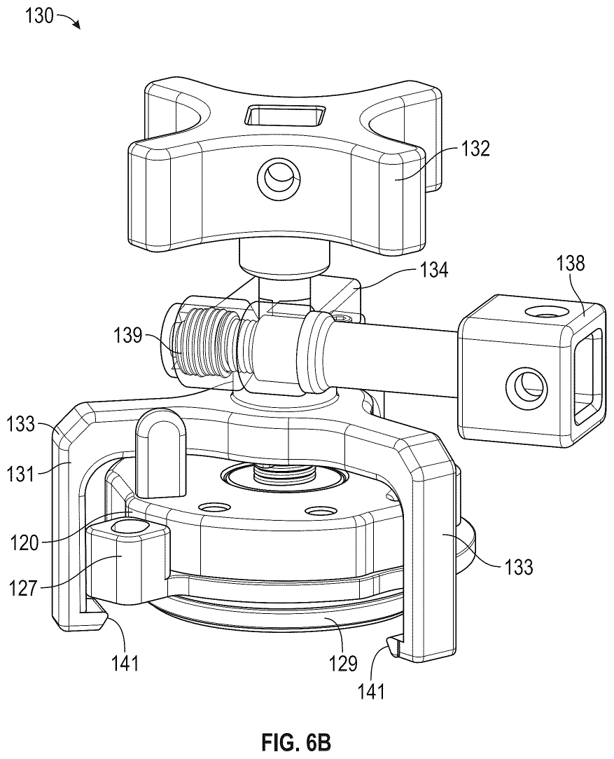

The container body 110 may include one or more an alignment pins 114 configured to interface with the lid assembly 120. The alignment pins 114 may be situated at a proximal, or top, end of the container body 110, the open end of the body 110 receiving the sample. The alignment pins 114 may be inserted within an aperture 127 of a cap member 123 the lid assembly 120. For example, each alignment pin 114 may be inserted into a corresponding aperture 127. An exemplary aperture 127 is depicted in FIGS. 6A and 6B.

The container body 110 may include a compressive material 116 configured to form a knife edge seal. An exemplary compressive material 116 may be copper, aluminum, Indium, or polytetrafluoroethylene (PTFE). A knife edge 125 of the cap member 123 may cut into the compressive material 116 to form the knife edge seal. It should be appreciated that the hardness of the knife edge material is higher than that of the compressive material 116. In some embodiments, the compressive material 116 may form a ring around the open end of the container body 110. In some embodiments, a wire 118 may seal the underside of the compressive material 116. The wire 118 may be composed of metal, for example indium.

The wire 118 and compressive material 116 may be situated within a groove of the container body 110. The wire 118 may be inserted into the groove before the compressive material 116. The wire 118 may be slid into the groove with the aid of a tool, for example a flat-head screwdriver. The compressive material 116 may then be loaded on top of the wire 118. The compressive material 116 may include projections 117 that allow the compressive material 116 to be secured to the container body 110 with one or more fasteners, for example bolts or screws.

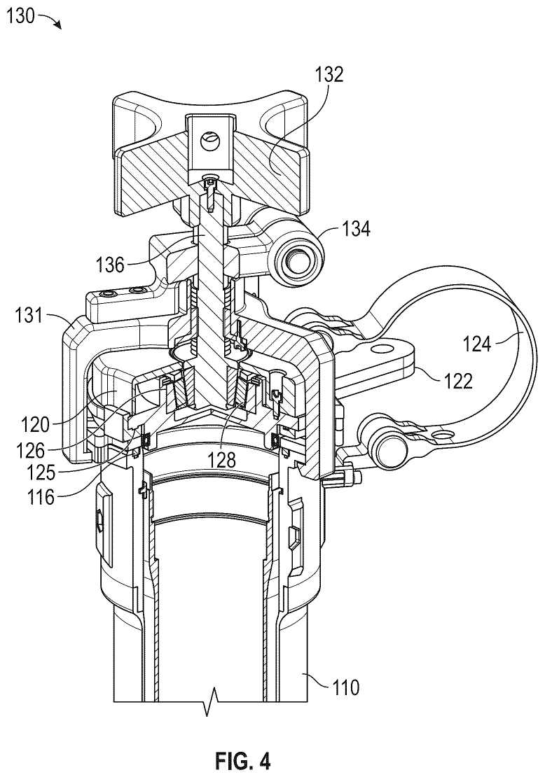

Referring now to FIG. 4, the lid assembly 120 may include one or more dust covers 122. In some embodiments, the container 100 includes two dust covers 122 adjacent to one another, one dust cover 122 seated at the bottom of the lid assembly 120 and another dust cover 122 seated at the top of the container body 110. The dust covers 122 may be configured to prevent dust from entering the container body 110 or from preventing formation of the seal between the lid assembly 120 and the container body 110 prior to insertion of the drive tube 200. In other words, the dust covers 122 are disposed between the knife edge 125 and the compressible material 116 to prevent deformation of the compressible material 116 until the forming of a seal is desired.

The lid assembly 120 may be connected to the container body 110 by a strap assembly 124. The strap assembly 124 may include one or more straps connected to a cover of the lid assembly 120 and the outer surface of the container body 110. The strap assembly 124 may allow the lid assembly 120 to remain connected to the container body 110 while a sample is loaded into the body 110. In an embodiment, the strap assembly 124 includes a relatively thin and wide strap c-shaped body having hinge members arranged at each end. The strap assembly 124 allows the lid assembly to be rotated relative to the container body 110 to allow the insertion of the drive tube 200.

The lid assembly 120 may further include a containment seal 129 situated at the bottom of the lid assembly 120. The containment seal 129 extends about the periphery of a projection in the cap member 123 and is configured to form a sliding seal that reduces introduction of contaminants into a sample housed within the container 100. In some embodiments, the containment seal 129 is composed of a polymeric material, for example polytetrafluoroethylene.

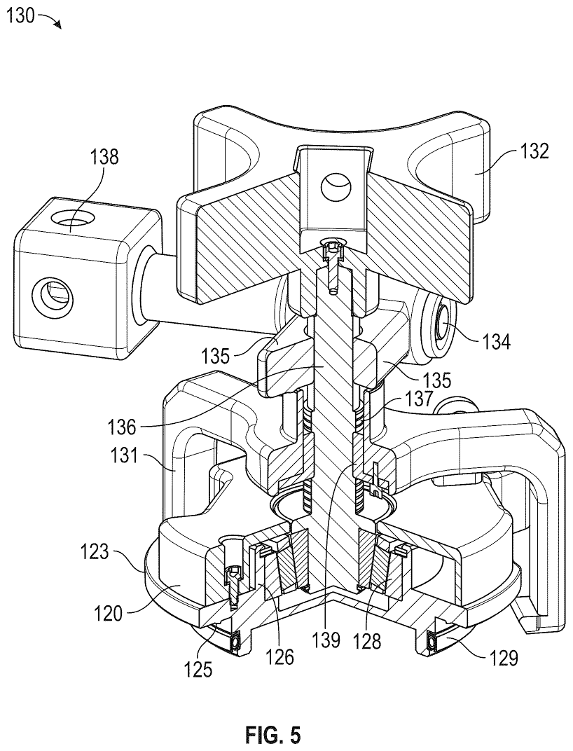

Referring now to FIGS. 5, 6A, and 6B the locking mechanism 130 may include a handle 132 situated at the top of the locking assembly. The handle 132 is configured to be twisted or otherwise manipulated by a user, for example, and astronaut. In embodiments where the handle 132 is designed for use by an astronaut, the handle 132 may be sufficiently sized and shaped to be manipulated with the thick glove and limited dexterity of a spacesuit. In some embodiments, the handle 132 may be manipulated by a wrench. In some embodiments, multiple handles 132 may be included. Each of the multiple handles may be used separately or in conjunction with each other to increase a sealing force between lid assembly 120 and container body 110. A multi-handle design allows astronauts to achieve a higher sealing force using just their hand strength. The higher sealing force allows for the use of other sealing materials for the gasket other than a soft indium seal that was used with containers on the Apollo missions, which led to sample contamination issues. The added mechanical advantage comes from the distribution of force and reduced input torque on each lead screw necessary to seal.

The locking mechanism 130 may further include a locking clamp 134 operably connected to the handle 132. In an embodiment, the locking clamp 134 includes a pair of arms 135 that extend about a preload shaft 136. As discussed below, the arms 135 are configured to squeeze or clamp about the shaft 136 to prevent rotation of the shaft and lock the shaft 136 in place. In an embodiment, the shaft 136 has an end in physical contact with a surface of the cap member 123 of the lid assembly 120. The shaft 136 includes one or more threaded portions 137 that allow the shaft 136 to translate relative to claw member 131 and compress the shaft 136 against the lid assembly 120 to form the seals described herein and further secure the lid assembly 120 against the container body 110. In an embodiment, the threaded portions 137 engage a threaded collar 139 (e.g. a locking Heli-Coil™) that is coupled to the claw members 131.

Additionally or alternatively, locking mechanism 130 may include a latch. The latch may be selectively coupled with one of handle 132, shaft 136, arms 135, or the like. The latch may be configured to be manually actuated (e.g., by a gloved human such as an astronaut). Moreover, locking mechanism 130 may include a cap or nut configured to operably couple shaft 136 with claw members 131. Accordingly, the cap or nut may prevent relative motion between shaft 136 and claw members 131 to ensure lid assembly 120 remains fastened to container body 110. In some embodiments, a secondary container (e.g., a separate vessel from vacuum sealable container 100) may include one or more locking features to which lid assembly (e.g., handle 132, shaft 136, claw members 131, etc.) may be attached to prevent or reduce the risk of a loosening thereof.

In some embodiments, the lid assembly 120 includes one or more rings 126 situated around the shaft 136. The rings 126 may include angled surfaces that engage corresponding surfaces on the shaft 136 to distributed the forces generated by the shaft 136 on the lid assembly 120 and also keep the shaft 136 centered thereon. The lid assembly 120 may include one or more tapered roller bearings 128 configured to reduce friction generated by compression of the shaft 136.

The locking mechanism 130 may include a locking bolt 138 configured to lock the locking clamp 134 around the shaft 136. In some embodiments, the locking clamp 134 includes a retaining ring situated around a threaded collar 139 of the locking bolt 138. The threaded collar 139 may include threading around a distal end of the locking bolt 138. When actuated, the rotation of the locking bolt 138 causes the arms 135 of the locking clamp 134 to compress onto the shaft 136.

The locking mechanism 130 may include a claw member 131. The claw member 131 includes a plurality of arms 133 may extend over the lid assembly 120 and attach to the container body 110. In an embodiment, each of the plurality of arms 133 includes a lip 141. In operation, each lip 141 engages grooves in the container body 110, such that when the handle 132 is rotated, the claw member 131 engages the container body 110 and allows the lid assembly 120 to be translated under the force of shaft 136 into the container body to form the seals described herein.

In some embodiments, prior to insertion of the drive tube 200, when the lid assembly 120 and the locking mechanism 130 are placed on the container body 110, the handle 132 may be rotated counterclockwise to lower the claw member 131 out of a stowed position to a lower position. At this point, the dust covers 122 may be removed and the drive tube inserted. The lid assembly 120 and the locking mechanism 130 may then be rotated to fit the claw member 131 within one or more grooves located on the container body 110. After fitting the claw member 131 into the grooves, a user may rotate the handle clockwise, causing the threaded portions 137 of the shaft 136 to translate the claw member 131 to engage the container body 110. Once engaged, further rotation of the handle 132 causes the lid assembly 120 into the container body 110 to seal the drive tube 200 within the container body 110. The user may then tighten the locking bolt 138 to lock the handle 132 in place and keep the seals from disengaging.

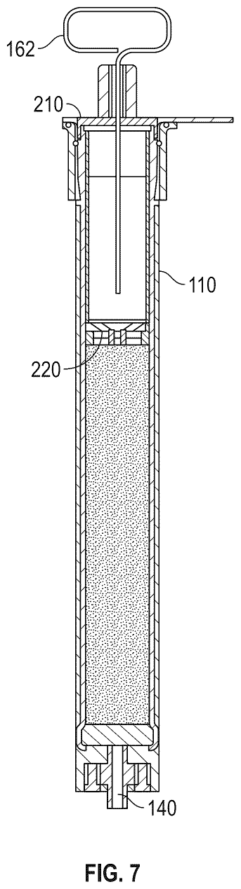

Referring now to FIG. 7 a plug 220 may be employed to compress a sample within the vacuum sealable container 100. For example, the plug 220 may be pushed into the container body 110 by a ram rod 162. During compression of the sample, the lid assembly 120 and connected locking mechanism 130 may sit outside the container body 110, or be connected to the body 110 by the strap assembly 124.

Referring now to FIG. 8, a sample may be provided in a drive tube 200. A proximal, or top, end 202 of the drive tube 200 may be screwed onto a keeper 210. In some embodiments, the plug 220 may be composed of a metallic or polymeric material. A distal, or bottom, end 204 of the drive tube 200 may be covered with a cap 230. In some embodiments, the cap 230 may be composed of polytetrafluoroethylene. It should be appreciated that in some embodiments where the sample does not completely fill the drive tube 200, the plug 220 may be disposed within the drive tube 200, similar to that shown in FIG. 7. In this embodiment, one or more additional components may be disposed between the plug 220 and the keeper 210 to keep the plug in contact with the sample while it is being transported.

The drive tube 200 may be inserted into the container body 110 such that the cap 230 contacts the gas fitting 140. In some embodiments, the drive tube 200 may be rotated within the container body 110 until the drive tube 200 locks into place within the soft dock 150.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A vacuum sealable container for securing and transporting extraterrestrial samples comprising:
a container body;
a lid assembly comprising a dust protector and a knife edge element that forms a seal between the container body and the lid assembly, the lid assembly connectable to the container body configured to selectively form a hermetic two-way seal between the container body and the lid assembly, wherein the lid assembly is connected to the container body by a strap assembly, wherein the container body comprises an alignment pin that engages with the lid assembly;
a locking mechanism situated on an end of the lid assembly opposite the container body, the locking mechanism configured to secure the lid assembly to the container body, forming the seal, wherein the locking mechanism comprises:
a handle;
a locking clamp operably connected to the handle;
a shaft in physical contact with the lid assembly, the locking clamp configured to compress the shaft against the lid assembly;
a locking bolt configured to lock the locking clamp around the shaft;
a gas fitting situated at a distal end of the container body, wherein the gas fitting is configurable between a closed position and an open position, the gas fitting defining a fluid path between the container body and an external environment to allow extraction of one or more gases; and
a drive tube situated within the container body.

2. A vacuum sealable container for securing and transporting extraterrestrial samples comprising:
a container body;
a lid assembly connectable to the container body configured to selectively form a hermetic two-way seal between the container body and the lid assembly; and
a locking mechanism situated on an end of the lid assembly opposite the container body, the locking mechanism configured to secure the lid assembly to the container body, forming the seal.

3. The container of claim 2, wherein the lid assembly includes a knife edge element that forms the seal between the container body and the lid assembly.

4. The container of claim 2, further comprising a gas fitting situated at a distal end of the container body.

5. The container of claim 4, wherein the gas fitting is configurable between a closed position and an open position, the gas fitting defining a fluid path between the container body and an external environment to allow extraction of one or more gases.

6. The container of claim 2, further comprising a drive tube situated within the container body.

7. The container of claim 6, further comprising a soft dock situated within the container body and proximate to the lid assembly, the soft dock configured to engage the drive tube and prevent rotation and axial motion of the drive tube.

8. The container of claim 2, wherein the lid assembly further comprises a dust protector.

9. The container of claim 2, wherein the lid assembly is connected to the container body by a strap assembly.

10. The container of claim 2, wherein the container body comprises an alignment pin that engages with the lid assembly.

11. The container of claim 2, wherein the locking mechanism comprises:
a handle;
a locking clamp operably connected to the handle;
a shaft in physical contact with the lid assembly, the locking clamp configured to compress the shaft against the lid assembly; and
a locking bolt configured to lock the locking clamp around the shaft.

12. A method of securing an extraterrestrial sample, comprising:
inserting the extraterrestrial sample into a container body;
enclosing the extraterrestrial sample within the container body with a lid assembly, the lid assembly connectable to the container body and configured to selectively form a hermetic two-way seal between the container body and the lid assembly; and
forming the seal by securing the lid assembly to the container body with a locking mechanism situated on an end of the lid assembly opposite the container body.

13. The method of claim 12, further comprising compressing the extraterrestrial sample before enclosing the container body.

14. The method of claim 12, further comprising extracting gases from within the container body.

15. The method of claim 12, wherein volatile gases are extracted through a gas fitting situated at a distal end of the container body from the lid assembly.

16. The method of claim 12, wherein the seal is a knife-edge seal.

17. The method of claim 12, wherein the extraterrestrial sample is contained within a drive tube before insertion into the container body.

18. The method of claim 12, wherein securing the lid assembly to the container body comprises:
actuating a handle operably connected to a locking clamp to compress a shaft against the lid assembly; and
locking the locking clamp around the shaft with a locking bolt.
